(19) United States
(12) Patent Application Publication
(10) Pub. No.: US 2004/0261284 A1
(43) Pub. Date: Dec. 30, 2004

(54) Device for drying or steaming stacked wood in a treatment room

(76) Inventor: Kurt Muhlbock, Eberschwang (AT)

Correspondence Address: WILLIAM COLLARD, COLLARD & ROE, P.C., 1077 NORTHERN BOULEVARD, ROSLYN, NY, 11576, US

(21) Appl. No.: 10/864,013

(22) Filed: Jun. 9, 2004

(30) Foreign Application Priority Data
Jun. 13, 2003 (AT) A 922/2003

(51) Int. Cl. F26B 19/00

(52) U.S. Cl. 34/218

(57) ABSTRACT

A device for drying or steaming stacked wood in a treatment room (2), which is accessible from at least one side for introducing and/or removing the wood stacks (1), particularly via a charging door (3), and which has at least one holding unit (4) for securing the wood stacks (1) in their particular positions against unacceptable inclinations. In order to provide advantageous construction conditions, it is suggested that the holding unit (4) be mounted on a ceiling construction (5) of the treatment room (2) and be displaceable from a rest position (R), which releases the charging room (8) of the treatment room (2) for at least one wood stack (1) at a time, into a securing position (S), which secures the wood stack(s) (1) in its/their position.

### FIELD OF THE INVENTION

The present invention relates to a device for drying or steaming stacked wood in a treatment room, which is accessible from at least one side for introducing and/or removing the wood stacks, particularly via a charging door, and which has at least one holding unit for securing the wood stacks in their particular positions against unacceptable inclinations.

### DESCRIPTION OF THE PRIOR ART

In devices of this type, either hot air or hot steam is circulated in the treatment room to treat the wood, through which moisture is either withdrawn from or supplied to the wood as required. For treatment progress which is as efficient as possible, it is necessary for the treatment air to be able to pass over the largest possible wood surface. Therefore, round wood is typically cut up before treatment, after which the cut boards or posts are assembled into packets, which are usually cuboid, with stacking slats interposed. By interposing the stacking slats, the pieces of wood do not lie directly one on top of another, so that a free space arises between each layer, through which the drying air may pass. Typically, multiple wood stacks are stacked behind, next to, and/or on top of one another in the treatment room in order to be able to treat multiple stacks in one batch, through which the device may be operated more economically.

Deformations of the boards or posts typically occur in the course of the treatment, which may result in value losses of the dried wood. The final deformation after a completed drying procedure may be reduced, for example, if the wood is prevented from deforming by mechanically fixing the individual layers of a wood stack to one another during the treatment, which is automatically the case in the lower packets due to the intrinsic weight of the loading upper wood stack when packets are stacked one on top of another. However, in order to also keep the deformation low in the boards of the upper packets after the drying, massive weights are often laid on the uppermost packet layer in order to be able to also keep the boards of the uppermost stack in shape.

In practice, problems frequently arise in this case with the stability of the wood stacks, since they often become unstable during a treatment and fall over inside the treatment room, through which not only significant damage to the device, but rather even injury to personnel may occur. This instability may have greatly varying causes. Thus, the stacking slats, which are relatively narrow in comparison to the board layers to be treated, may be overloaded by the loading weight and squashed, through which they lose their dimensional stability and the wood stacks may receive unacceptable inclinations. Frequently, the stacking slats also do not lie exactly one on top of another and/or parallel to one another, so that the load resting on them leads to a bending load of the layers on one side and therefore also to an inclination of the stack tower. Due to the deformation of the stacked boards during the drying, the packet and stack structure loosens, so that eccentricities which are initially small during the stack tower formation may lead to a progressive stack inclination on one side. The weights laid on top also shift the center of gravity of the stack column upward, through which the stability of the entire structure is further reduced. Similar conditions also result in devices for steaming wood, since the steamed wood becomes partially plastic, so that a slight initial lateral inclination may easily lead to an instability of the entire stack. In order to prevent the wood stacks from falling over in the charging direction, until now, for example, columns or supports anchored in the floor have been provided at the back of the treatment room, which the stack towers are placed against in order to prevent the stacks from falling over. It is more difficult to prevent the stacks from falling over in the direction of the charging door, since permanently installed columns on this side would prevent charging of the treatment room. For this purpose, support constructions are known which, after the chamber is filled, are either leaned on the wood stacks, braced against them, or put under the stacks like bookends, so that they support the stacks. This known solution has been shown to have the disadvantage that the chamber charging is made more complex by introducing, removing, and temporarily storing the additional extensive and heavy support constructions to be provided, which additionally require significant space in the chamber, through which effective treatment area is wasted. In addition, if the packet has leaned against the support, it is difficult with the known embodiments to remove the packet with a stacker, since the supports must be removed simultaneously with the wood stack, which causes significant handling problems.

In order to counteract the known disadvantages, keeping wood stacks in their shape during the treatment process using tension straps is known (U.S. Pat. No. 5,382,123 A1, GB 1 077 486 A, U.S. Pat. No. 4,314,783 A). However, the manual application of the tension straps typically interferes with the automated flow in production. In addition, straps of this type are usually made of highly flexible materials which are not durably resistant in the treatment atmosphere, which is typically very hot and moist, and therefore must be replaced frequently.

### SUMMARY OF THE INVENTION

The present invention is therefore based on the object of providing a device of the type cited at the beginning, using which the above-mentioned disadvantages may be avoided in a simple way and using which wood stacks introduced into a treatment room may be kept in their desired position during the treatment procedure without great complexity, and without excessively hindering the introduction into and/or the removal of the wood stacks from the treatment room.

The present invention achieves this object in that the holding unit is mounted on a ceiling construction of the treatment room and is displaceable from a rest position, which releases the charging room of the treatment room for at least one wood stack at a time, into a securing position which secures the wood stack(s) in its/their position.

The device according to the present invention is equipped with one or more holding units which, in their securing position, project in front of the wood stack from above in such a way that they reliably prevent the wood stacks from falling over. The holding units are anchored permanently to the device and project downward from the ceiling construction at least enough that they support a significant part of the particular uppermost wood packet. In practice, depending on the high of the entire stack, a minimum coverage height from approximately 0.8 to 1 meter has been shown to be necessary. Using a holding unit of this type, slipping of the stack front edge, particularly toward the charging direction of the stack, is prevented, so that unacceptable inclinations of the wood stacks are reliably avoided even in the initial state. The holding units may also be positioned on the ceiling construction in such a way that it is possible to charge the treatment room with wood stacks positioned on rail cars. In this case, the holding units particularly prevent the stacks from falling over transversely to the passage direction of the rail cars through the treatment room during the treatment procedure. To move the rail cars in and out, the holding units are merely pivoted away from the wood stacks and/or displaced into the rest positions, which release the wood stacks, through which possible projecting boards or stacking slats are prevented from being stripped off as the rail cars travel. For stacker-charged devices, the holding units, which are shifted into their securing position, project into the charging room of the device in order to avoid tilting of the wood stacks opposite to the charging direction. Inclinations of the wood stacks in the charging direction toward the rear wall of the treatment room may be prevented either also using a holding unit according to the present invention or using known columns, which are provided on the rear of the treatment room, anchored in the floor, for example, and possibly supported on a ceiling construction, against which the stack towers may be laid and/or placed.

The central advantages of the present invention are that endangerment of people and the facility due to wood stacks falling over or boards or weights falling down may no longer occur, the availability of the drying facility increases, since shutdowns because of stacks falling over and/or damaged facility parts no longer occur, and the repair costs for damage of this type are dispensed with. Possible tendencies to tilt are already suppressed in the initial stage, through which the forces to be absorbed by the ceiling construction remain minimal. In addition, the quality of the dried boards is improved, because the prevention of stack deformation also reduces the deformation of the boards themselves. Weights may be used without restrictions, which further increases the economic usefulness of the present invention.

Especially space-saving construction conditions result for the holding unit if it includes a pivot lever pivotably mounted on the ceiling construction, which is pivotable out of its rest position, pivoted against the ceiling of the treatment room, into an at least approximately vertical securing position in front of the wood stack(s). In this case, the forces acting on the holding unit due to the stacks leaning against it are absorbed by the ceiling construction. The wood stacks, after they have been moved to their desired location and after the pivot lever is pivoted into its securing position, are fixed directly in their position, so that complex manual securing work no longer must be performed.

If especially large forces are to be absorbed by the holding units, and/or if the wood stacks are to be supported over their entire height, it is advisable if the holding unit includes at least one support bracket, which is displaceable on the ceiling construction transversely to the charging direction of the wood stack, which is displaceable from a rest position, provided lateral to the wood stack and releasing the charging room of the particular wood stack, into a securing position in front of the particular wood stack. The support bracket of the at least one holding unit may preferably be moved on a rail transversely to the charging direction of the wood stack in this case, through which the clearance necessary for charging and/or removing the wood stacks is released. If the support bracket is not completely supported on a ceiling construction in this case, it is suggested that the support bracket extend into the floor region of the treatment room and be fixable in the securing position in relation to the floor using a locking device.

Locking the holding unit in its securing position is necessary in any case in order to reliably suppress inclinations of the wood stacks, the locking able to be performed either through a mechanical, hydraulic, or motorized actuation, or by engaging a special locking mechanism. Mechanical locking of the shifting movement is possible through an actuating lever extending from the holding unit, for example, which activates the locking devices on the holding units. Locking may also be performed, for example, by plugging bars into the chamber floor or into the ceiling construction. In order to ensure that wood stacks of greatly varying external dimensions may be reliably prevented from falling down in the treatment room, the holding unit may be attached to a girder whose position in relation to the charging direction of the treatment room on the ceiling construction is adjustable as a function of the position of the wood stacks. Furthermore, multiple rows of wood stacks may each be supported by a separate holding unit or the lined up wood stacks may be secured against unacceptable inclinations together by at least one holding unit.

In order to ensure that the holding units are positioned and designed in such a way that, if the stacks are placed against the holding units, a stacker may raise the relevant packet between the holding units using the stacker forks without any additional device and therefore secure it, it is advisable if the holding unit is attached to a girder whose position is adjustable transversely to the charging direction of the treatment room on the ceiling construction as a function of the position and length of the stack and/or the stacker width. The holding units may thus be easily displaced into their rest position if wood stacks are secured by the stacker, before the stacker removes the secured packet from the chamber.

Especially advantageous construction conditions result if the holding unit has locking devices connected to a control unit, which are preferably actuatable hydraulically or electromechanically via the control unit. Therefore, the holding units may easily be displaced into their rest position and/or into their securing position as needed from a control center or from the stacker using radio activation, through which the operating complexity of the holding unit is significantly reduced. In addition, it may be ensured if necessary that the treatment procedure is only started when the wood stacks are secured.

### BRIEF DESCRIPTION OF THE DRAWING

The present invention is schematically illustrated in the drawing on the basis of an exemplary embodiment.

FIG. 1 shows a detail of a device according to the present invention in a side view,

FIG. 2 shows the device from FIG. 1 in section along line II-II in a reduced scale,

FIG. 3 shows a construction variation of a device according to the present invention in detail in a partially cutaway side view, and

FIG. 4 shows the device from FIG. 3 in section along line IV-IV

### DESCRIPTION OF THE PREFERRED EMBODIMENTS

A device for drawing or steaming wood stacks 1 includes, among other things, a treatment room 2, which is accessible for introducing and/or removing the wood stacks 1 via a charging door 3 and which has holding units 4 for securing the wood stacks 1 in their particular position against unacceptable inclinations. The holding units 4 are mounted on a ceiling construction 5 of the treatment room 2 and are supported on the foundation 6 via the ceiling construction 5 and the walls and/or girders of the treatment room 2. The wood stacks 1 are positioned in multiple rows next to and/or behind and on top of one another in the treatment room on indicated pallets 7, the individual wood, stacks 1 being made of profiled pieces of wood layered with stacking slats interposed. In order to be able to keep the individual wood stacks 1 securely in their position during the treatment procedure and/or in order to secure the wood stacks 1 from falling over, the holding units 4 are displaceable from a rest position R, which releases the charging room 8 of the treatment room 2 for at least one wood stack 1 at a time, into a securing position S, which secures the wood stacks 1 in their position.

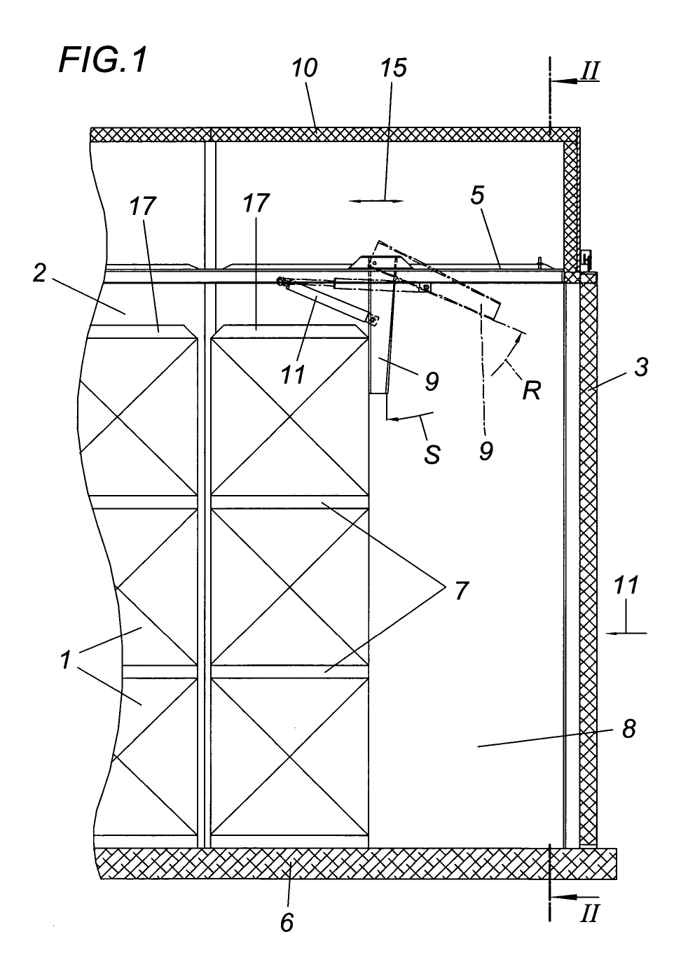

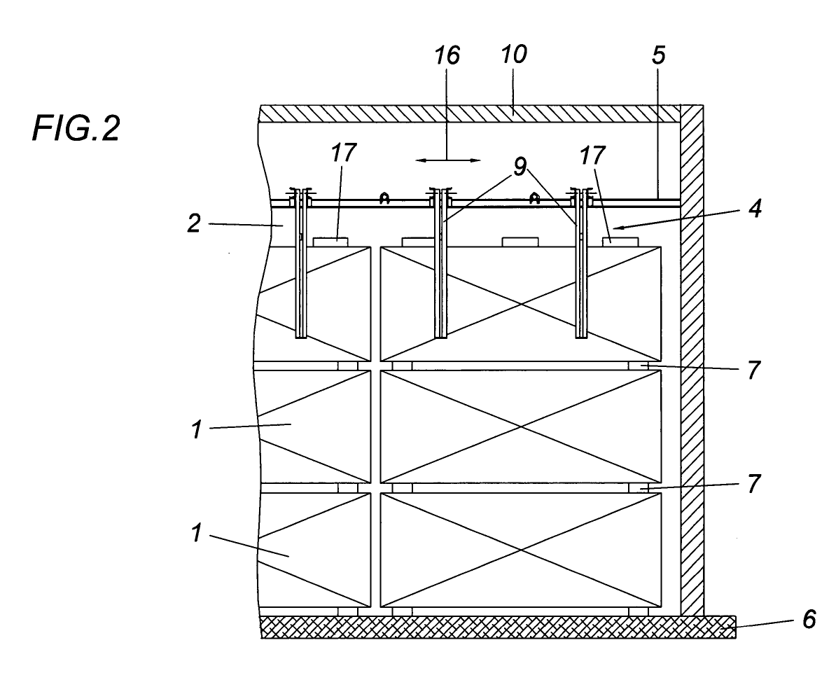

According to the embodiment variation shown in FIGS. 1 and 2, holding units 4 are formed by pivot levers 9 pivotably mounted on the ceiling construction 5, which are pivotable from their rest position R, pivoted against the ceiling of the treatment room and releasing the charging room 8 of the treatment room 2, into an at least approximately vertical securing position S. Hydraulic cylinders 11 are provided for pivoting the pivot levers 9, which engage on the ceiling construction 5 and on the pivot levers 9 and, as necessary, either pivot the levers away from the particular wood stack 1 or pivot them against the wood stack 1.

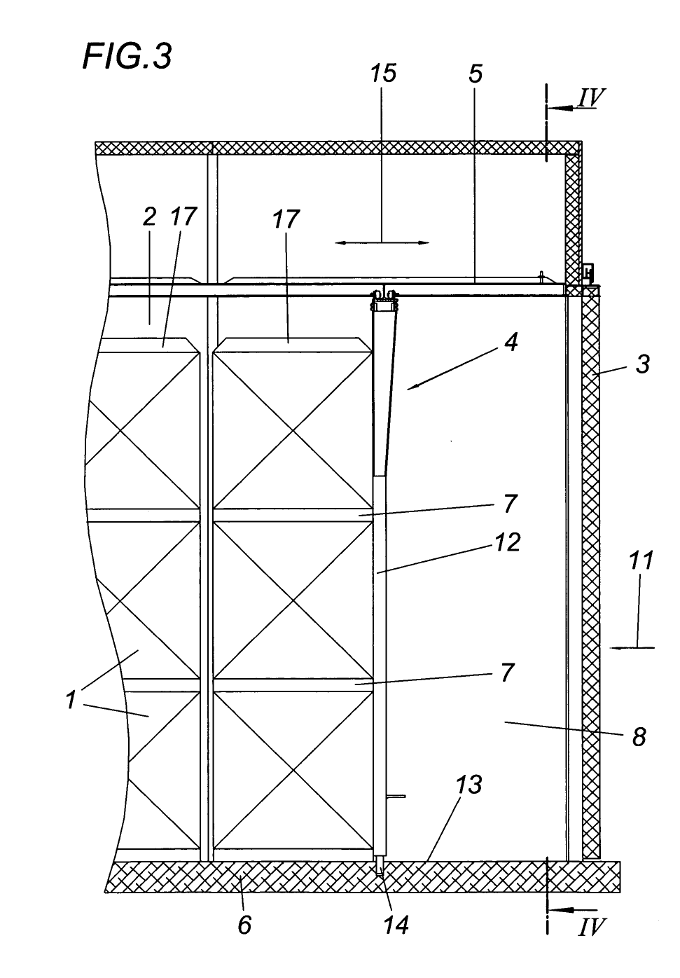

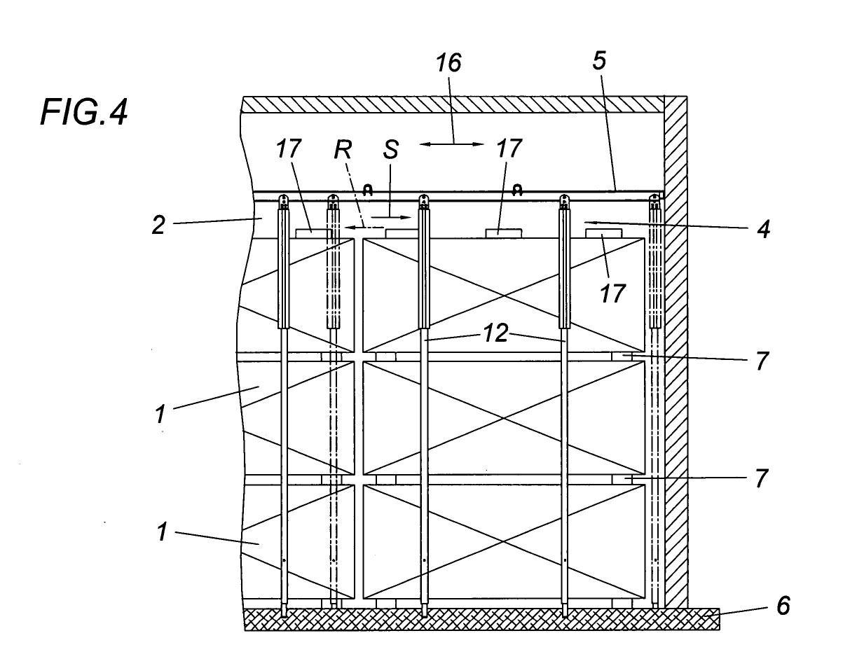

According to the construction variation shown in FIGS. 3 and 4, the holding unit 4 includes multiple support brackets 12, which are displaceable transversely to the charging direction 11 of the wood stacks 1, and which are displaceable from a rest position R, provided laterally to the wood stacks and releasing the charging room 8 of the particular wood stack 1, into a securing position S in front of the particular wood stack 1. The support brackets 12 extend from their mounting on the ceiling construction 5 into the floor region of the treatment room 2 and may be fixed in the securing position in relation to the floor 13 using a locking device 14 in order to secure the individual wood stacks 1 in their position against falling over in the best way possible.

In order to be able to adjust the position of the holding units 4 in the treatment room 2 in relation to the charging direction 11, the holding units are attached to a girder (not shown), whose position in relation to the charging direction 11 is adjustable along the direction 15. The position of the holding units 4 on the ceiling construction 5 transverse to the charging direction 11 of the treatment room 2 is also adjustable in direction 16 as a function of the position and length of the wood stacks 1. The wood stacks are additionally weighted with weights 17.

1. A device for drying or steaming stacked wood in a treatment room, which is accessible from at least one side for introducing and/or removing the wood stacks, particularly via a charging door, and which has at least one holding unit for securing the wood stacks in their particular positions against unacceptable inclinations, characterized in that the holding unit (4) is mounted on a ceiling construction (5) of the treatment room (2) and is displaceable from a rest position (R), which releases the charging room (8) of the treatment room (2) for at least one wood stack (1) at a time, into a securing position (S), which secures the wood stack(s) (1) in its/their position.

2. The device according to claim 1, characterized in that the holding unit (4) includes a pivot lever (9), pivotably mounted on the ceiling construction (5), which is pivotable from its rest position (R), pivoted against the ceiling (10) of the treatment room (2), into an at least approximately vertical securing position (S).

3. The device according to claim 1, characterized in that the holding unit (4) includes at least one support bracket (12), which is displaceable on the ceiling construction (5) transversely to the charging direction (11) of the wood stack (1), and which is displaceable from a rest position (R), provided lateral to the wood stack (1) and releasing the charging room (8) of the particular wood stack (1), into a securing position (S) in front of the particular wood stack (1).

4. The device according to claim 3, characterized in that the support bracket (12) extends into the floor region of the treatment room (2) and may be fixed in the securing position (S) in relation to the floor using a locking device.

5. The device according to one of claims 1 through 4, characterized in that the holding unit (4) is attached to a girder whose position on the ceiling construction (5) in relation to the charging direction (11) of the treatment room (2) is adjustable as a function of the position of the wood stack (1).

6. The device according to one of claims 1 through 5, characterized in that the holding unit (4) is attached to a girder, whose position on the ceiling construction (5) transverse to the charging direction (11) of the treatment room (2) is adjustable as a function of the position and length of the wood stack (1).

7. The device according to one of claims 1 through 6 having a control unit, characterized in that the holding unit (4) includes locking devices connected to a control unit.

8. The device according to claim 7, characterized in that the locking devices are actuatable hydraulically or electromechanically via the control unit.
